(19) United States
(12) Patent Application Publication
(10) Pub. No.: US 2005/0202135 A1
(43) Pub. Date: Sep. 15, 2005

(54) Adhesive for animal and fishery products and process for producing adhered and formed foods using the adhesive

(75) Inventors: Tomoko Kaneko, Kawasaki-shi (JP); Yuuichi Oosumi, Tokyo (JP); Hiroyuki Nakagoshi, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Ajinomoto Co., Inc., Tokyo (JP)

(21) Appl. No.: 11/047,679

(22) Filed: Feb. 2, 2005

Related U.S. Application Data
(63) Continuation of application No. PCT/JP03/09502, filed on Jul. 25, 2003.

(30) Foreign Application Priority Data
Aug. 2, 2002 (JP) 225580/2002

(51) Int. Cl. A23L 1/31

(52) U.S. Cl. 426/272

(57) ABSTRACT

Adhesives for animal and fishery products comprising a transglutaminase, a milk protein powder, and one or more salts, meeting certain requirements, are effective for forming adhered and restructured foods.

### CROSS REFERENCES TO RELATED APPLICATIONS

This application is a continuation of International Patent Application No. PCT/JP03/09502, filed on Jul. 25, 2003, and claims priority to Japanese Patent Application No. 225580/2002, filed on Aug. 2, 2002, both of which are incorporated herein by reference in their entireties.

### BACKGROUND OF THE INVENTION

1. Field of the Invention

The present invention relates to an adhesive for animal meat and fishery products which is useful for producing adhered and formed (restructured) foods by adhering food raw materials such as animal and fishery meats, and a process for producing such adhered and restructured foods using the adhesive.

2. Discussion of the Background

To date, various methods have been employed for producing adhered foods by adhering and restructuring food raw materials such as animal and fishery meats. Examples of such methods include using a protein material or thickening polysaccharides as a paste, using these materials in combination with alkaline materials, and the like. However, most of these methods have been functionally insufficient in view of a food adhesive because the adhesion strength is unsatisfactory, and the appearance, taste, and flavor of the food raw materials are notably impaired.

One approach for solving these problems is a method using a transglutaminase-based adhesive made of a combination of a transglutaminase, as an enzyme, and caseins. This method makes it possible to produce adhered and restructured foods in which the appearance, taste, and flavor of the food raw materials are not impaired at all.

However, the transglutaminase, which is used as a hardening agent in the transglutaminase-based adhesive, is an enzyme, and the obtained adhesion strength depends on the amount of the transglutaminase, the reaction temperature, and the reaction time. With respect to these parameters, the use of a large amount of transglutaminase is disadvantageous in regard to production cost, and increasing the reaction temperature is undesirable in regard to sanitary control such as maintenance of freshness in the case when the raw materials are fresh raw materials such as animal and fishery meats. Accordingly, when the reaction is conducted with a small amount of a transglutaminase at a low temperature, it is required to take a long adhesion time. However, a long adhesion time is also problematic in regard to production efficiency and sanitary control. The adhesive disclosed in JP-A-6-284867 is excellent, because its practical use is possible in a reaction at 5° C. for 1 hour.

However, in actual production, a food adhesive which exhibits higher adhesion strength in a shorter reaction time has been in demand for the purposes of further increased productivity and further improved sanitation control. A reduction in the reaction time is especially desired in connection with the production of adhered and restructured foods of animal and fishery products, for which it is difficult to take a long reaction time because of the hygiene issue. A reduction of the reaction time is especially desired in a method in which an adhesive powder is applied for adhesion (hereinafter referred to as “a powder sprinkling method”).

### SUMMARY OF THE INVENTION

Accordingly, it is one object of the present invention to provide novel adhesives for animal meat and fishery products.

It is another object of the present invention to provide novel adhesives which are useful for producing adhered and formed (restructured) foods.

It is another object of the present invention to provide novel adhesives which are useful for producing adhered and formed (restructured) foods by adhering food raw materials such as animal and fishery meats.

It is another object of the present invention to provide novel transglutaminase-containing adhesive preparations which enable stronger adhesion in a shorter reaction time without increasing the mixing amount of transglutaminase and without impairing the appearance, taste, and flavor of the food raw materials, especially animal and fishery products.

It is another object of the present invention to provide novel process for producing an adhered and restructured food by using such an adhesive.

It is another object of the present invention to provide novel adhered and restructured food prepared by such a method and with such an adhesive.

These and other objects, which will become apparent during the following detailed description, have been achieved by the inventors' discovery that by incorporating, in addition to a transglutaminase and a milk protein powder, a salt that shows alkalinity and meets specific conditions (hereinafter referred to as an alkaline salt), the reaction time required until practical adhesion strength is obtained is shortened and a higher adhesion strength is obtained. This finding has led to the completion of the invention. The effect of the present invention is especially outstanding in the powder sprinkling method.

That is, the present invention provides an adhesive for animal and fishery products, comprising a transglutaminase, a milk protein powder, and a salt for which the pH of a 1% (% is hereinafter all by w/w) aqueous solution is at least 10 and less than 13 and the solubility of the salt at 20° C. is at least 20% and less than 100%. Further, the present invention provides an adhesive for animal and fishery products in which the pH of a 2% aqueous solution of the adhesive is at least 9 and less than 10.

Moreover, the present invention provides an adhesive for animal and fishery products in which the pH of a 1% aqueous solution of the salt is at least 10 and less than 13 and solubility of the salt at 20° C. of a salt is at least 100%, the pH of a 2% aqueous solution of the adhesive is at least 7.5 and less than 10. The present invention also provides methods for producing an adhered and restructured food using such an adhesive for animal and fishery products and the adhered and restructured foods so produced.

### DETAILED DESCRIPTION OF THE PREFERRED EMBODIMENTS

The invention is described in detail below.

The alkaline salt used in the present invention is characterized in that the pH of a solution of the alkaline salt alone is sufficiently high and the solubility thereof in water is also high. The pH of the alkaline salt alone is preferably at least 10 and less than 13 in a 1% aqueous solution. Furthermore, a salt in which the solubility in water at 20° C. is at least 20% and less than 100% is preferably used. Examples of alkaline salts that meet such conditions include sodium carbonate, trisodium phosphate, tripotassium phosphate, sodium glycinate, potassium glycinate, and the like. Of these, sodium carbonate gives the highest effect to adhesion strength, and is also less costly and relatively stable so that it is easy to handle.

Alkaline salts in which the pH of a 1% aqueous solution is less than 10 or salts whose solubility at 20° C. is less than 20% are less effective for shortening the reaction time. Further, salts in which the pH of a 1% aqueous solution is 13 or more are undesirable, because the activity of a transglutaminase becomes unstable when in the form of an adhesive powder for animal and fishery products. Examples of salts in which the pH of a 1% aqueous solution of the salt alone is 10 or less include sodium hydrogencarbonate (bicarbonate), sodium polyphosphate, and trisodium citrate; and examples of salt in which the pH of a 1% aqueous solution of the salt alone is 13 or more include sodium hydroxide and potassium hydroxide. Examples of salts whose solubility at 20° C. is less than 20% include tetrasodium pyrophosphate and calcium oxide (calcined calcium). From these salts, no satisfactory effect can be expected as the salt of the present invention.

Further, the pH of the adhesive is preferably at least 9 and less than 10 when in a 2% aqueous solution (20° C.). With a pH of less than 9 and a pH of 10 or more, the effect of shortening the reaction time is not obtained or is very low. It is thus advisable that the mixing amount of the alkaline salt is adjusted such that the pH of the adhesive in a 2% aqueous solution (20° C.) is in this range.

However, in case of using salts with a solubility at 20° C. which exceeds 100%, such as tetrapotassium pyrophosphate and potassium carbonate, an effect of shortening a reaction time is found when the pH of a 2% aqueous solution of the adhesive is at least 7.5 and less than 10. Accordingly, tetrapotassium pyrophosphate and potassium carbonate can be used to attain the object of the present invention so long as pH of a 2% aqueous solution of the adhesive preparation containing the same is at least 7.5 and less than 10.

Preferably, the salt is present in an amount of greater than 0.3% to less than 10% by weight, even more preferably 1% to less than 10% by weight, based on the total weight of the adhesive.

When the adhesive is used in the power sprinkling method, it is advisable that the particle size of the alkaline salt is small. Specifically, the particles preferably have an average particle size of from 20 to 150 μm, and the particles having a size of 250 μm or less account for at least 80% by weight of the total weight of the salt. It is more preferable to use particles in which the particles which have a size of 250 μm or less account for at least 90% by weight of the total weight of the salt. The use of alkaline salts having a small particle size shortens the reaction time required for adhesion and improves the adhesion strength, and further the amount of the alkaline salts incorporated into the adhesive can be reduced. This method is especially effective when alkaline salts having a strong taste are used or it is desired to reduce the deterioration of the flavor of a material to be adhered.

Sodium carbonate is a white powder or mass. As the powder, two types, “light ash” having a small particle size and a low specific gravity and “heavy ash” having a large particle size and high specific gravity are marketed, and selectively used according to the purpose. In most cases, it is heavy ash (average particle size approximately 500 μm) that is generally distributed in the market. Heavy ash is easy to handle because of lower dust, but the particle size thereof is large. Accordingly, light ash having a small particle size (average particle size is from approximately 100 to 150 μm) is preferable for the adhesive for animal and fishery products in the present invention.

JP-A-6-284867 describes that a pH adjustor can be used in an adhesive. However, there is no disclosure at all suggesting a specific pH adjustor, a method for using the same and how to shorten the reaction time. Further, an enzyme preparation for noodles containing a transglutaminase, a carbonate, and a protein hydrolyzate is known (see, JP-A-11-346689). However, this preparation is used to modify noodles by generating a carbon dioxide gas. Therefore, this enzyme preparation is different from the product of the present invention in regard to the problem solved, the mechanism, as well as in requirements.

The milk protein as the other effective ingredient is described below. As the milk protein powder, any of sodium caseinate, potassium caseinate, calcium caseinate, and the like can be used so long as a casein protein prepared from milk is contained therein. A milk protein powder which is partially hydrolyzed by a method such as acid hydrolysis, alkali hydrolysis, or enzymatic hydrolysis is also available. However, with a higher rate of hydrolysis, the adhesion strength tends to decrease. The mixing ratio of the milk protein powder based on the total amount of the adhesive for animal and fishery products is preferably from 30 to 90%, more preferably from 40 to 70%. When the mixing ratio is low, no satisfactory adhesion strength is obtained. When it is too high, the adhesion strength is not increased according to the mixing ratio, and the relatively expensive milk protein powder is consumed which is economically disadvantageous.

The transglutaminase used in the present invention is an enzyme that catalyzes an acyl transfer reaction of a γ-carboxamide group of a glutamine residue in a peptide chain. This transglutaminase forms ε-(γ-Glu)-Lys crosslinks in and between protein molecules when an ε-amino group of a lysine residue in a protein acts as an acyl receptor. It is further an enzyme that proceeds with a reaction in which a glutamine residue is deamidated into a glutamic acid residue when water acts as an acyl receptor.

Such transglutaminases include calcium-independent transglutaminases and calcium-dependent transglutaminases. The former include an enzyme derived from microorganisms (see, for example, JP-A-1-27471, which is incorporated herein in its entirety), and the latter include an enzyme derived from the guinea pig's liver (see, JP-B-1-50382, which is incorporated herein in its entirety), an enzyme derived from fish (see, for example, Seki Nobuo et al. Nihon Suisan Gakkaishi, vol. 56, No. 1, p. 125 (1990), which is incorporated herein in its entirety), and the like. Further, it includes enzymes produced by gene recombination (see, JP-A-1-300889, JP-A-5-199883, JP-A-6-225775, which are incorporated herein in its entireties, and the like). In the adhesive for animal and fishery products of the present invention, any of these transglutaminases can be used, and the origin and the production process thereof are not limited. However, in view of functionality and economics, a calcium-independent transglutaminase is preferable. For example, a transglutaminase derived from microorganisms is optimal at present because it satisfies all of the conditions.

The mixing amount of the transglutaminase in the adhesive for animal and fishery products of the present invention is from 1 to 500 units, preferably from 20 to 100 units per gram of the adhesive. When the addition amount of the transglutaminase is less than 1 unit, no satisfactory adhesion strength is obtained. When it is more than 500 units, the adhesion rate is too high which decreases handling efficiency and is also economically disadvantageous.

The activity unit of the transglutaminase is measured and defined as follows. That is, a reaction is conducted using benzyloxycarbonyl-L-glutaminylglycine and hydroxylamine as substrates, the resulting hydroxamic acid is purified, and the purified hydroxamic acid is formed into an iron complex in the presence of trichloroacetic acid. Thereafter, the absorbance at 525 nm is measured, and the amount of hydroxamic acid is obtained from a calibration curve to calculate activity (see the above-mentioned JP-A-1-27471, which is incorporated herein by reference in its entirety).

The adhesive for animal and fishery products of the present invention can contain, as required, seasonings such as table salt, sugar, or pepper; emulsifying agents such as lecithin or monoglyceride; and bulking agents such as lactose or dextrin, unless the adhesion of the transglutaminase and the milk protein is impaired.

In the case of conducting adhesion by the powder sprinkling method, it is more effective that fine particle silicon dioxide is properly mixed as disclosed in JP-A-8-140594, which is incorporated herein by reference in its entirety.

There is no special difficulty in preparing the adhesive for animal and fishery products of the present invention by employing appropriate amounts of these ingredients, and it can be prepared by simple powder mixing. The thus-prepared adhesive can of course be used directly in adhering food raw materials. Needless to say, it can be distributed as a food additive.

A method for adhering a material to be adhered by the powder sprinkling method using the foregoing adhesive is described below. The powder of the adhesive is spread on a tray or the like. A material to be adhered, such as meat, is lightly put on the powder, rolled and coated well with the powder. The adhesive-coated material is restructured by being filled in a casing tube or laminated on a die box. When a gap remains between adhered surfaces, this portion is hard to adhere. It is thus advisable to adhere the materials to be adhered by pressing or the like.

This adhered and restructured product is kept at a predetermined temperature for a predetermined time depending on the purpose, to permit the crosslinking reaction of the transglutaminase to proceed. Since the transglutaminase is an enzyme, the foregoing predetermined temperature and time are determined in consideration of conditions under which to activate the enzyme. Adhesion is typically conducted at a temperature which is lower than that at which the transglutaminase is deactivated, i.e., lower than 60 to 70° C. The higher the temperature, the faster the adhesion strength increases. However, when animal and fishery products which are to be adhered are fresh food raw materials, it is advisable that they are treated at from 0 to 10° C. to maintain freshness. The necessary reaction time varies with the reaction temperature and the type or the condition of the material to be adhered. The necessary adhesion strength is usually attained in a time of from 5 minutes to 15 hours. Of course, when the reaction proceeds for a longer time than this range, there is no problem in adhesion strength. By using the adhesive for animal and fishery products of the present invention, the necessary enzyme reaction time can be, for the same enzyme amount, from ½ to ¼ that required for ordinary adhesive preparations using a transglutaminase. Further, when the reaction time is long enough, a higher adhesion strength than in the past can be obtained.

The thus-adhered material can be distributed as such or after being heated or frozen. Further, it can be eaten immediately after being heated or can be distributed after being chilled or frozen. During that time, the material may be cut to an appropriate size as required. Specifically, fish may be processed into sashimi (sliced raw fish), roasted fish, cooked fish, fry, or the like, and animal meat may be processed into steak, fry, or the like. The adhesive for animal and fishery products of the present invention, like ordinary adhesives, can also be used in a water-dissolving method in which the adhesive powder is dispersed or dissolved in water (the water is used in an amount of from 2 to 10 times by weight that of the adhesive powder), and the solution of the adhesive powder is mixed with a material to be adhered, followed by restructuring. The adhesive for animal and fishery products of the present invention, like ordinary adhesives, can also be used in a powder scattering method in which the adhesive powder is mixed with a material to be adhered by scattering, followed by restructuring.

Food raw materials to be adhered with the adhesive for animal and fishery products of the present invention can include all of animal and plant raw materials such as animal meat (including poultry), fish meat, shellfoods, eggs, vegetables, and fruits. These can be adhered products either as such or by heat treatment such as boiling, roasting, steaming, or grilling, by treatment with acid or alkali or by flavoring with seasonings such as salt, soy sauce, sugar, or the like. In addition, two or more of these adhered products may be combined.

Further, the adhesive of the present invention particularly improves the reaction at a low temperature. Since the reaction is further improved at room temperature or in a high temperature zone capable of activating the transglutaminase, productivity may be increased or the amount of enzyme may be decreased when an ordinary reaction time is employed. Thus, it goes without saying that the adhesive of the present invention provides economic advantages.

Other features of the invention will become apparent in the course of the following descriptions of exemplary embodiments which are given for illustration of the invention and are not intended to be limiting thereof.

### EXAMPLES

### Example 1

Adhesives (a) to (h) for animal and fishery samples were prepared by mixing raw materials according to Table 1. The percentage amounts in Table 1 are all by weight based on the total weight of the adhesive. As the transglutaminase, a transglutaminase (specific activity 1 unit/mg) derived from a microorganism (Streptverticillium mobaraense IFO 13819) belonging to an actinomyces of Streptverticillium (which is sometimes classified in Streptomyces) was used. As the milk protein powder, a sodium caseinate powder was used. As sodium carbonate (anhydrous), a sodium carbonate (anhydrous) light ash (average particle size 120 μm, 250 μm or less 96%) manufactured by K.K. Tokuyama was used. As the fine particle silicon dioxide, Silopage #720 manufactured by Fuji Silicia Kagaku K.K. was used.

TABLE 1

| | Recipe of adhesive (unit: %) | | | | | | | |
|---|---|---|---|---|---|---|---|---|
| | (a) | (b) | (c) | (d) | (e) | (f) | (g) | (h) |
| Transglutaminase | 5 | 5 | 5 | 5 | 5 | 5 | 5 | 5 |
| Sodium caseinate | 50 | 50 | 50 | 50 | 50 | 50 | 50 | 50 |
| silicon dioxide | 0 | 2 | 2 | 0 | 0 | 0 | 0 | 2 |
| Sodium polyphosphate | 0 | 0 | 5 | 0 | 0 | 0 | 0 | 0 |
| Tetrasodium pyrophosphate | 0 | 0 | 0 | 5 | 0 | 0 | 0 | 0 |
| Sodium carbonate | 0 | 0 | 0 | 0 | 5 | 0 | 0 | 5 |
| (anhydrous) light ash | | | | | | | | |
| Trisodium phosphate | 0 | 0 | 0 | 0 | 0 | 5 | 0 | 0 |
| Tetrapotassium | 0 | 0 | 0 | 0 | 0 | 0 | 5 | 0 |
| pyrophosphate | | | | | | | | |
| Lactose | 45 | 43 | 38 | 40 | 40 | 40 | 40 | 38 |
| pH (20° C.) of | 6.3 | 6.3 | 8.2 | 8.1 | 9.9 | 9.9 | 7.8 | 9.9 |
| 2% adhesive aqueous solution | | | | | | | | |
| Adhesion strength (g/cm²) | 52 | | | | 98 | | | |
| Reaction time 10 min | | | | | | | | |
| Adhesion strength (g/cm²) | 73 | 85 | 90 | 95 | 113 | 101 | 116 | 125 |
| Reaction time 30 min | | | | | | | | |
| Adhesion strength (g/cm²) | 86 | | | | 119 | | | |
| Reaction time 60 min | | | | | | | | |
| Adhesion strength (g/cm²) | 100 | 110 | 114 | | 128 | 120 | | 136 |
| Reaction time 120 min | | | | | | | | |

Each of these adhesives was spread on a tray to a thickness of approximately 5 mm. Small pieces (approximately 2 cm square) of raw pork meat (ham) were rolled thereon to uniformly adhere the adhesive thereto. These were filled in a cylindrical casing with a folded width of 75 mm, and bound while being pressed. The casing was kept at 5° C. for from 10 minutes to 2 hours to cause an enzyme reaction with the transglutaminase. Then, the sample was completely frozen in a freezer of −30° C. to stop the enzyme reaction. Subsequently, the sample was half-thawed, and sliced to a thickness of 9 mm. The slices were further cut to a rectangular shape 25 mm in width. They were subjected to a tensile test with a rheometer manufactured by Fudo Kogyo K.K. immediately after completely thawed. The adhesion strength was expressed in terms of tensile strength (g/cm²). Moreover, the pH of a 2% aqueous solution of each adhesive was measured by using a pH meter. In the preparation of the 2% aqueous solution of the adhesive, the adhesive powder was added to water, and the mixture was stirred for 5 minutes, after which the pH at a water temperature of 20° C. was measured. The results are shown in Table 1.

The adhesives for animal and fishery samples, containing sodium carbonate, trisodium phosphate, and tetrapotassium pyrophosphate needed shorter time for adhesion than (a), (b), (c) and (d) obtained by the ordinary method to increase the adhesion strength. Further, the combined use of fine silicon dioxide (h) showed higher adhesion strength.

The adhered sample of ham which had been obtained by an adhesion treatment with each of the adhesives (a) to (h) for a reaction time of 30 minutes was sliced to a steak having a thickness of from 10 to 12 mm. Both surfaces thereof were roasted on a hot plate at approximately 200° C. for 2 minutes each, and the sample was pulled by hand for the comparison of the adhesive strength. Consequently, the meats treated with (e), (f), (g) and (h) were adhered with sufficient adhesion strength in handling. However, the adhered meats treated with adhesives (a), (b), (c) and (d) were easy to collapse, and the adhesion strength was unsatisfactory. All of the adhered meats maintained a flavor and a mouthfeel equal to those of non-adhered meat in which the taste and flavor inherent in meat were not impaired at all.

### Example 2

4.5% by weight of the same transglutaminase (specific activity 1 unit/mg) derived from a microorganism as used in Example 1, 50% by weight of a sodium caseinate powder and 2% by weight of fine silicon dioxide were mixed with from 1 to 10% of sodium carbonate (anhydrous) having different particle sizes, and the remainder of a maltitol syrup powder such that the total weight became 100%. Twelve types of adhesives for animal and fishery samples were thus prepared, and an adhered sample of ham was prepared in the same manner as in Example 1 using the same. By the way, the sodium carbonate used was light ash (average particle size 120 μm, 250 μm or less 96%) and heavy ash (average particle size 500 μm, 250 μm or less 6%) manufactured by K.K. Tokuyama. The reaction was conducted at 5° C. for 30 minutes. After completion of the reaction, the sample was completely frozen in a freezer of −30° C. In the same manner as in Example 1, half-thawing and slicing were conducted, and a tensile test was conducted with the rheometer to measure adhesion strength. The pH of a 2% aqueous solution of each adhesive was also measured as in Example 1. The results are shown in Table 2. When the mixing amount of sodium carbonate (anhydrous) was from 2 to 5% by weight based on the total weight of the adhesive, in which the pH of the 2% aqueous solution of the adhesive was from 9 to 10, an especially high adhesion strength was obtained, and the use of light ash having a small particle size gave an even higher adhesion strength in a small mixing amount.

TABLE 2

| Mixing amount | | | |
|---|---|---|---|
| (%) | | Tensile strength | |
| of sodium | pH of a 2% | (g/cm²) | |
| carbonate | aqueous solution | Adhesive | Adhesive |
| (anhydrous) | (20° C.) | using light ash | using heavy ash |
| 0 | 6.3 | 87 | 87 |
| 1 | 7.6 | 102 | 91 |
| 2 | 9.0 | 110 | 95 |
| 2.5 | 9.3 | 125 | 104 |
| 3 | 9.6 | 118 | 107 |
| 5 | 9.9 | 107 | 115 |
| 10 | 10.4 | 97 | 90 |

### Example 3

A largehead hairtail fish (Trichiurus lepturus) was cut to three parts, and the bone was removed to obtain slices (approximately 5 cm×10 cm). The preparation (c), (e), or (h) obtained in Example 1 was coated on the bowel sides thereof. The bowel sides of the two slices were adhered, and covered with a wrap. The sample was kept at 5° C. for 2 hours to proceed with an enzyme reaction by a transglutaminase. The resulting sample was completely frozen in a freezer of −30° C. to stop the enzyme reaction. Subsequently, the sample was thawed. Immediately after the sample was completely thawed, a peeling test was performed by ten expert panels. The adhesion strength was manually evaluated, and the average value was obtained. In the evaluation, “strongly adhered” scored 10, “tentatively adhered but easily separated by pulling” scored 5, and “not adhered at all” scored 1. Using this scale, (c) was evaluated as 5.5, (e) as 6.7, and (h) as 7.1, respectively. Further, the samples were eaten by being properly roasted on a hot plate of 200° C. As a result, all of the samples maintained a flavor and a mouthfeel equal to those of a non-adhered slice of a cutlass in which a taste and a flavor inherent in fish were not impaired at all.

### INDUSTRIAL APPLICABILITY

The present adhesive, comprising the combination of transglutaminase, milk protein powder, and the specific alkaline salt, has enabled a higher adhesion strength to be obtained in a shorter reaction time than in the prior art with respect to the adhesion of foods using an enzyme-containing adhesive.

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. An adhesive for animal and fishery products, comprising:
(a) a transglutaminase;
(b) a milk protein powder; and
(c) a salt,
wherein a 1% (w/w) aqueous solution of said salt exhibits pH of at least 10 and less than 13, and said salt has a solubility in water at 20° C. of at least 20% (w/w) and less than 100% (w/w).

2. The adhesive for animal and fishery products of claim 1, wherein said salt has an average particle size of from 20 to 150 μm and particles having a size of 250 μm or less account for 80% by weight or more of the total weight of said salt.

3. The adhesive for animal and fishery products of claim 1, wherein a 2% aqueous solution of said adhesive exhibits a pH of at least 9 and less than 10.

4. The adhesive for animal and fishery products of claim 3, wherein said salt has an average particle size of from 20 to 150 μm and particles having a size of 250 μm or less account for 80% by weight or more of the total weight of said salt.

5. The adhesive for animal and fishery products of claim 1, wherein said salt is at least one member selected from the group consisting of sodium carbonate, trisodium phosphate, tripotassium phosphate, and mixtures thereof.

6. The adhesive for animal and fishery products of claim 5, wherein said salt has an average particle size of from 20 to 150 μm and particles having a size of 250 μm or less account for 80% by weight or more of the total weight of said salt.

7. An adhesive for animal and fishery products, comprising:
(a) a transglutaminase;
(b) a milk protein powder; and
(c) a salt,
wherein a 1% (w/w) aqueous solution of said salt exhibits a pH of at least 10 and less than 13; said salt has a solubility in water at 20° C. of at least 100% (w/w); and a 2% (w/w) aqueous solution of said adhesive exhibits a pH of at least 7.5 and less than 10.

8. The adhesive for animal and fishery products of claim 7, wherein said salt has an average particle size of from 20 to 150 μm and particles having a size of 250 μm or less account for 80% by weight or more of the total weight of said salt.

9. The adhesive for animal and fishery products of claim 7, wherein said salt is at least one member selected from the group consisting of sodium carbonate, tetrapotassium pyrophosphate, and mixtures thereof.

10. The adhesive for animal and fishery products of claim 9, wherein said salt has an average particle size of from 20 to 150 μm and particles having a size of 250 μm or less account for 80% by weight or more of the total weight of said salt.

11. A method for producing an adhered and restructured food, comprising:
(1) treating a plurality of pieces of a food with an adhesive for animal and fishery products according to claim 1, to obtain pieces of a treated food;
(2) forming at least a portion of said pieces of treated food into a restructured food; and
(3) maintaining said restructured food within a predetermined temperature range, to obtain said adhered and restructured food.

12. The method of claim 11, wherein said salt has an average particle size of from 20 to 150 μm and particles having a size of 250 μm or less account for 80% by weight or more of the total weight of said salt.

13. The method of claim 11, wherein a 2% aqueous solution of said adhesive exhibits a pH of at least 9 and less than 10.

14. The method of claim 11, wherein said salt is at least one member selected from the group consisting of sodium carbonate, trisodium phosphate, tripotassium phosphate, and mixtures thereof.

15. An adhered and restructured food, which is prepared by a method according to claim 11.

16. A method for producing an adhered and restructured food, comprising:
(1) treating a plurality of pieces of a food with an adhesive for animal and fishery products according to claim 7, to obtain pieces of a treated food;
(2) forming at least a portion of said pieces of treated food into a restructured food; and
(3) maintaining said restructured food within a predetermined temperature range, to obtain said adhered and restructured food.

17. The method of claim 16, wherein said salt has an average particle size of from 20 to 150 μm and particles having a size of 250 μm or less account for 80% by weight or more of the total weight of said salt.

18. The method of claim 16, wherein said salt is at least one member selected from the group consisting of sodium carbonate, tetrapotassium pyrophosphate, and mixtures thereof.

19. The method of claim 18, wherein said salt has an average particle size of from 20 to 150 μm and particles having a size of 250 μm or less account for 80% by weight or more of the total weight of said salt.

20. An adhered and restructured food, which is prepared by a method according to claim 16.
